(19) United States
(12) Patent Application Publication
(10) Pub. No.: US 2008/0119236 A1
(43) Pub. Date: May 22, 2008

(54) Method and system of using mobile communication apparatus for translating image text

(75) Inventors: Po-Lung Chen, Chu-Tung (TW); Pei-Chun Chen, Chu-Tung (TW); Ko-Shyang Wang, Chu-Tung (TW); Chien-Chun Kuo, Chu-Tung (TW)

Correspondence Address: RABIN & Berdo, PC, 1101 14TH STREET, NW, SUITE 500, WASHINGTON, DC, 20005, US

(73) Assignee: INDUSTRIAL TECHNOLOGY RESEARCH INSTITUTE, Hsinchu (TW)

(21) Appl. No.: 11/700,941

(22) Filed: Feb. 1, 2007

(30) Foreign Application Priority Data
Nov. 22, 2006 (TW) 095143234

(51) Int. Cl. H04B 1/38

(52) U.S. Cl. 455/566

(57) ABSTRACT

A method and a system of using mobile communication apparatus to translate image text are provided, which are applicable to a translation service of transmitting an image text captured by a front-end mobile communication device via a wireless communication network to a back-end server for identification and translation, and feeding back the result to the mobile communication device. The method includes obtaining a digital image containing texts from a mobile communication device; transmitting the digital image to a back-end server via a wireless communication network to be identified as a corresponding text; translating the corresponding text into a description content in the same or different languages; and feeding back the description content to the mobile communication device to be displayed.

### CROSS-REFERENCE TO RELATED APPLICATIONS

This non-provisional application claims priority under 35 U.S.C. § 119(a) on Patent Application No(s). 095143234 filed in Taiwan, R.O.C. on Nov. 22, 2006, the entire contents of which are hereby incorporated by reference.

### BACKGROUND OF THE INVENTION

1. Field of Invention

The present invention relates to a method and a system of using mobile communication apparatus to translate image text, and more particularly to a method and a system that captures an image by a front-end mobile communication device, transmits the image to a back-end server to be translated into a text description, and feeds back the text description to the front-end.

2. Related Art

At present, mobile phones or personal digital assistants (PDAs) are provided with translation function. However, as the key-in or handwriting input speed of a mobile phone or PDA still has room to be improved, or the interface is not convenient enough, or the system of a mobile phone or PDA even does not have the input interface of the required language, the utilization of a mobile phone or PDA for translation is excessively low. The input on a translator or computer is more convenient, but people may not always carry a translator or computer when needed, especially outdoors. Therefore, some involved in this field recently proposes a technology of employing a front-end mobile device to provide a specially marked image and feeding back the image via a communication network to a back-end for further processing. As shown in FIG. 1, U.S. Pat. No. 6,522,889 discloses a technology, wherein a geographic area image of a specific location is obtained by a camera 11 disposed or) a front-end mobile communication device 10; next, the image is transmitted through the wireless communication network of a general packet radio service (GPRS) network 12 and enters an Internet 14 via an Internet access 13; the image is converted by an optical character reader (OCR) server 15 communicated with the Internet 14 into a text type which is then compared with the geographic area database stored in a positioning server 16 also communicated with the Internet 14; finally, the accurate comparison position is fed back to the mobile communication device 10.

Though the above technology provides an architecture of processing an image by network transmission, the technology can only transmit an image of a specific geographic location captured by the front-end and transmitted to the back-end for adding an identification coordinate to position, while cannot translate texts of any language at the front-end.

### SUMMARY OF THE INVENTION

In view of the above disadvantages, the present invention is directed to providing a translation method, wherein an image is captured by a front-end mobile communication device and then transmitted to a back-end server with the text on the image identified, translated, and fed back. The present invention is also directed to providing a system of translating image text, wherein an image is captured by a front-end, identified and translated by a back-end via a mobile network connecting the front-end and back-end.

The method of using mobile communication apparatus to translate image text according to the present invention comprises: capturing an digital image containing image texts from a mobile communication device; transmitting the digital image to a back-end server, wherein the server identifies the digital image as a corresponding text via an OCR program and then translates the corresponding text into a text description content in the same or different languages via a translation program; and feeding back the description content to the mobile communication device to be displayed.

The above invention can be improved by finding out text image regions through an image processing program in advance during the identification of the texts in the digital image, so as to enhance the accuracy of the subsequent identification. In addition, a text group classification program can be further provided to classify the text image regions into a plurality of groups corresponding to letters, characters, or phrases.

The above invention can be further improved by providing boundary marks displayed on the display interface when the mobile communication device captures the image, so as to translate the image text closest to the center of the display interface, or by transmitting the position information of the marks together with the captured image to the back-end server after the marks are manually added into the display interface by a user, and then calculating the groups closest to the positions of the marks in the plurality of groups for further identification and translation operations.

The present invention utilizes a front-end mobile communication device to capture an image to be translated, then transmits the image to a back-end server for identification and translation, and finally feeds back the result to the mobile communication device to be displayed. As the current speed of mobile wireless net surfing is getting faster and faster, the time taken by transmission is not long, and the resolution of the image capture device on the mobile device is also raised rapidly, the characters or phrases in an image can be efficiently identified. Further, together with the stable and effective image background processing technology, image text identification technology, and translation technology available at present, the powerful data storage and operation processing functions of the server can be integrated with the convenience and flexibility of the mobile communication device to facilitate the user to translate at any time any place without requiring for key-in by hand. Particularly, the translation operation on some foreign language that cannot be directly input into a mobile communication device (the input method of the language of the country is not provided by the mobile communication device) can also be performed effectively.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, and thus is not limitative of the present invention, and wherein:

FIG. 1 is a conventional system block diagram of the position of an identification mobile communication device;

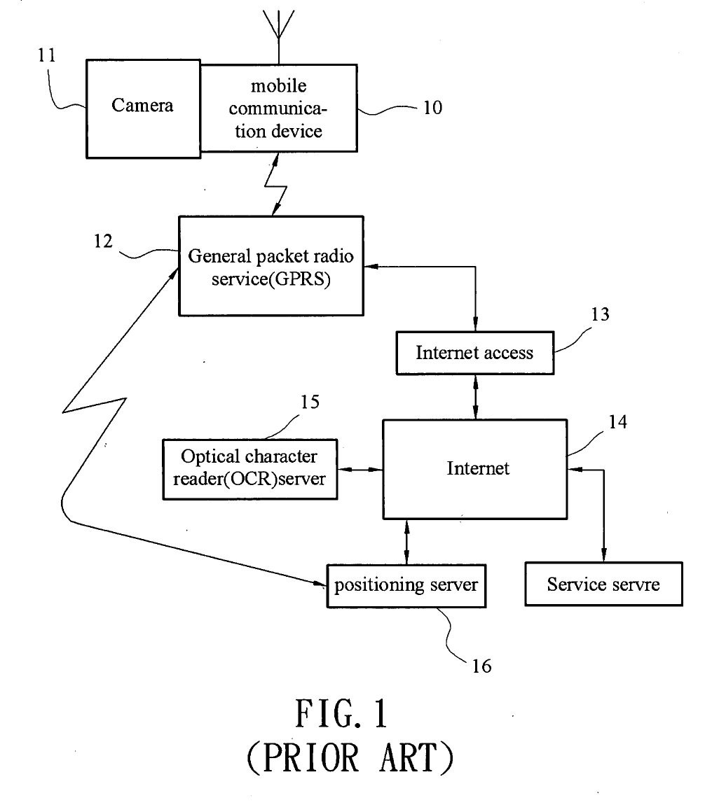

FIG. 2 is a system block diagram of a system of using mobile communication apparatus to translate image text according to an embodiment of the present invention;

FIG. 3 is a schematic view of the process of a method of using mobile communication apparatus to translate image text according to an embodiment of the present invention;

FIG. 4 is a schematic block diagram of the method of using mobile communication apparatus to translate image text according to an embodiment of the present invention;

FIG. 5 is a schematic view of the operations of the method of using mobile communication apparatus to translate image text according to an embodiment of the present invention; and

FIG. 6 is a schematic view of the operations of the method of using mobile communication apparatus to translate image text according to another embodiment of the present invention.

### DETAILED DESCRIPTION OF THE INVENTION

Preferred embodiments of the present invention are illustrated in detail below accompanied with drawings.

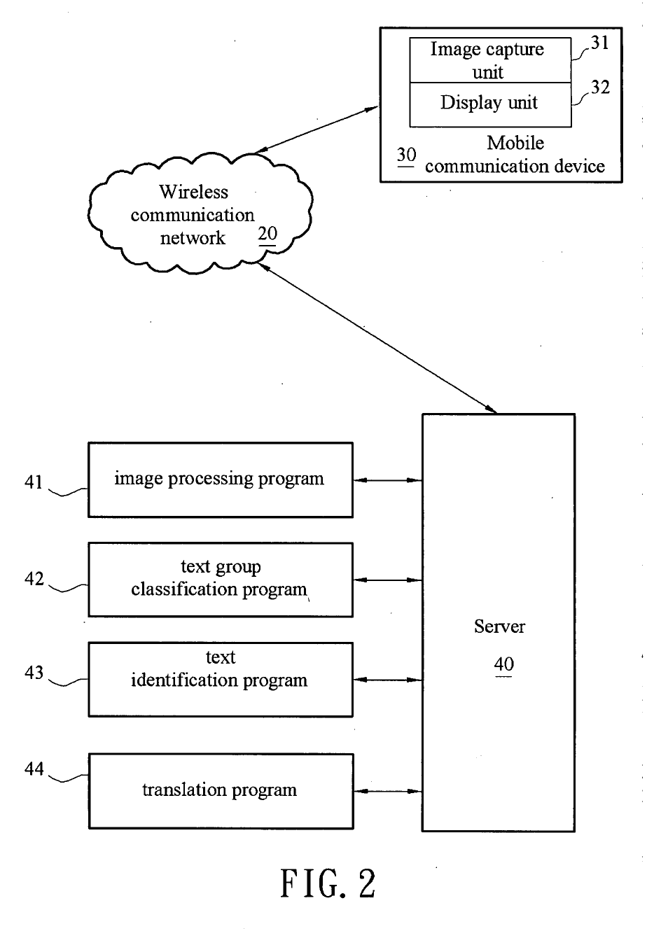

First, referring to FIG. 2, a system block diagram of a system of using mobile communication apparatus to translate image text according to an embodiment of the present invention is shown. The system includes a wireless communication network 20, a mobile communication device 30, and a server 40. The wireless communication network 20 employs a wireless communication technology such as GPRS or wireless fidelity (WiFi) to provide a data transmission platform. The mobile communication device 30 can be an apparatus with data transmission capability, such as a mobile phone, PDA, ultra mobile PC (UMPC), or notebook (NB). The mobile communication device 30 must have an image capture unit 31 and a display unit 32 disposed thereon, wherein the image capture unit 31 is a device such as a camera or a video recorder, which is mainly used for capturing a digital image 33 containing image texts and then transmitting the digital image 33 to the wireless communication network 20. The server 40 has an image processing program 41, a text group classification program 42, a text identification program 43, and a translation program 44. The server 40 is communicated with the wireless communication network 20 for performing image text region identification, text group classification, text identification, and translation program processing on the digital image 33 uploaded by the mobile communication device 30, so as to generate a description content 441 in the same or different languages. Afterward, the description content 441 is fed back via the wireless communication network 20 to the mobile communication device 30 and displayed by the display unit 32 of the mobile communication device 30.

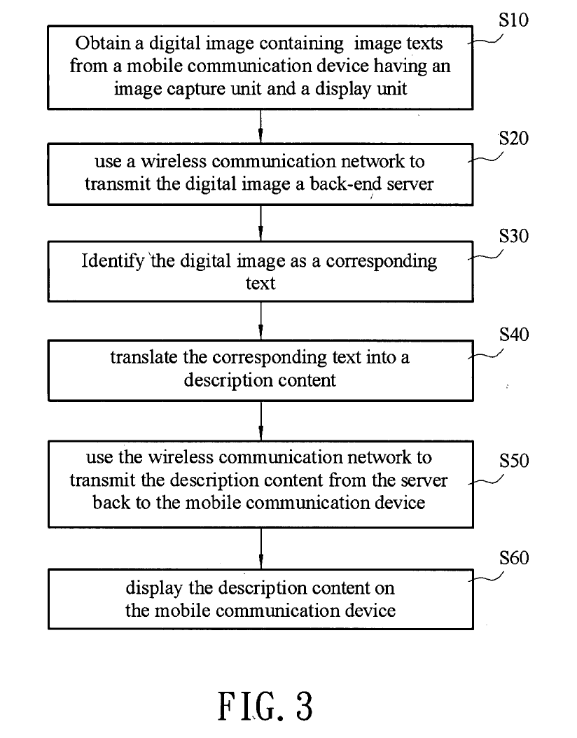

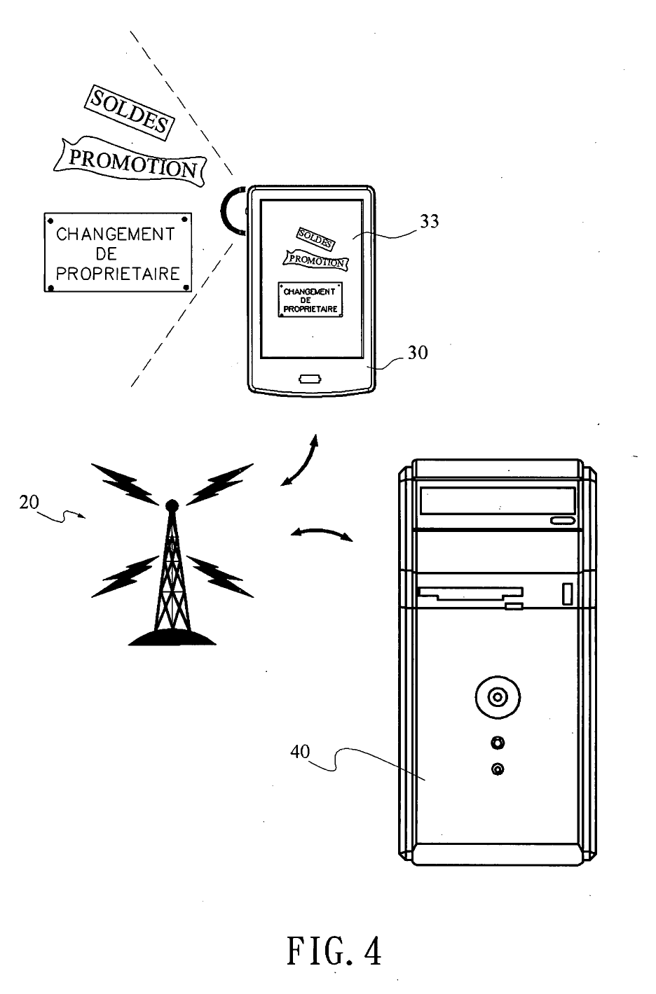

Next, referring to FIGS. 3 and 4, FIG. 3 is a schematic view of the process of a method of using mobile communication apparatus to translate image text according to an embodiment of the present invention, and FIG. 4 is a schematic block diagram of the method of using mobile communication apparatus to translate image text according to an embodiment of the present invention. The method includes: obtaining a digital image 33 containing image texts from a mobile communication device 30 having an image capture unit 31 and a display unit 32 (Step S10), wherein the image texts contained in the digital image 33 can be in data types such as words, phrases, or articles; using a wireless communication network to transmit the digital image from the mobile communication device 30 communicated therewith to a back-end server 40 (Step S20); identifying the digital image as a corresponding text (Step S30); translating the corresponding text into a description content (Step S40); using the wireless communication network to transmit the description content from the server back to the mobile communication device (Step S50); and displaying the description content on the mobile communication device (Step S60).

Before the Step S30 of identifying the digital image as a corresponding text by the server 40, the above embodiment further includes a step of using an image processing program 41 on the server 40 to perform various image processing technologies of image background removal, edge detection, or color regional segmentation, such as gray scaling, contrast improvement to find out text image regions, so as to raise the identification rate of the text identification program 43.

After the step of using an image processing program 41 to find out the text image regions, the above embodiment further includes a step of using a text group classification program 42 to classify the text image regions into a plurality of groups 421, 422 for being directly utilized by the subsequent text identification program 43.

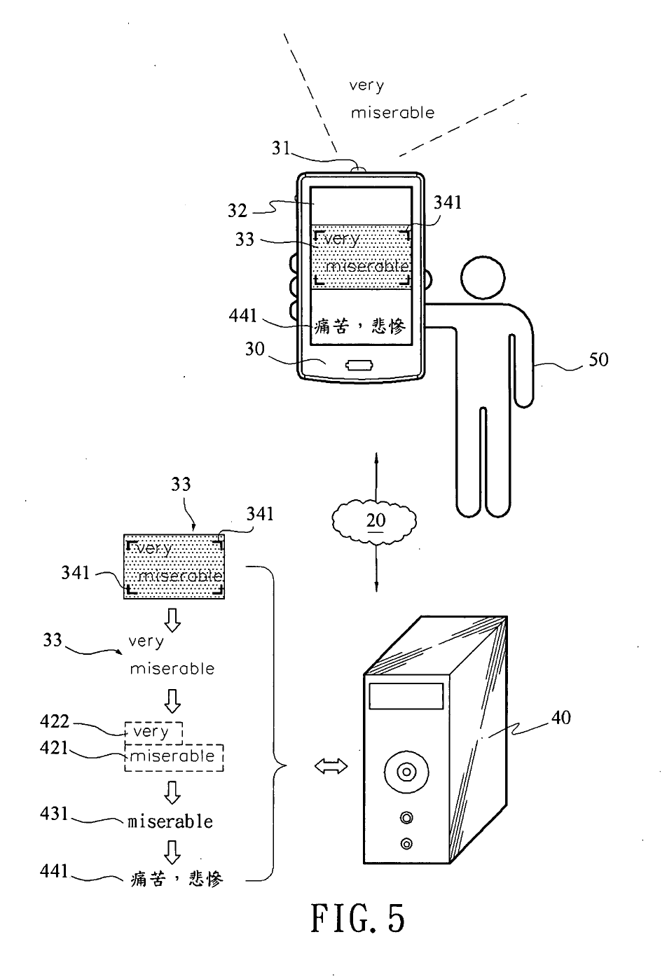

Afterward, referring to FIG. 5, a schematic view of the operations of the method of using mobile communication apparatus to translate image text according to an embodiment of the present invention is shown. In this embodiment, when a user 50 utilizes the image capture unit 31 of the mobile communication device 30 to capture a digital image 33 containing a text image, a boundary mark 341 can be further displayed on the interface of the display unit 32 of the mobile communication device 30, such that a portion of the text image to be translated is sufficiently enlarged and placed at the center of the display unit 32 when the user 50 is capturing the digital image 33. Then, the text image is transmitted to the server 40 via the wireless communication network 20, thus fulfilling the capture and transmission operations of the digital image 33.

After the portion of the text image to be translated is placed at the center of the boundary mark 341 of the display unit 32 to form a digital image 33 which is then transmitted to the server 40, the aforementioned text group classification program 42 is adopted to calculate a group 421 closest to the center of the digital image 33, i.e., the group 421 to be translated. Next, the group 421 undergoes a text identification operation to generate a corresponding text 431 of the image texts in the group 421, and then the corresponding text 431 undergoes a translation operation to be translated into a description content 441. Afterward, the description content 441 is fed back to the mobile communication device 30 via the wireless communication network 20 and then displayed by the display unit 32.

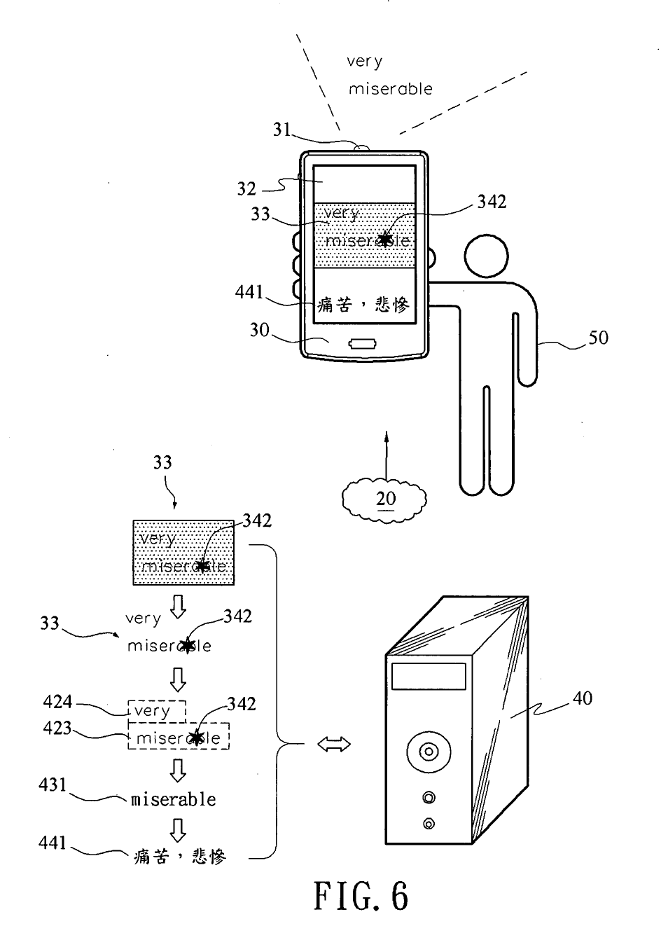

Further, referring to FIG. 6, a schematic view of the operations of the method of using mobile communication apparatus to translate image text according to another embodiment of the present invention is shown. In this embodiment, when the user 50 utilizes the image capture unit 31 of the mobile communication device 30 to capture a text image source, the user 50 can further display a mark 342 on the interface of the display unit 32 of the mobile communication device 30 within the scope of the image texts to be translated. The position information of the mark 342 is then transmitted to the back-end server 40 together with the digital image 33. Afterward, the aforementioned text group classification program 42 classifies the text image regions of the digital image 33 into a plurality of groups 423, 424, and calculates a group 423 of the digital image 33 closest to the position of the mark 342, i.e., the group 423 to be translated. Next, the group 423 undergoes a text identification operation to generate a corresponding text 431 of the image texts in the group 423, and then the corresponding text 431 undergoes a translation operation to be translated into a description content 441. The description content 441 is fed back to the mobile communication device 30 via the wireless communication network 20 and then displayed by the display unit 32.

Additionally, in the above embodiments, the step of obtaining a digital image 33 containing image texts from a mobile communication device 30 having an image capture unit 31 and a display unit 32 and the subsequent step of using a wireless communication network 20 to transmit the digital image 33 to a back-end server 40 may include the following two operation methods. One method is performing a step of using a wireless communication network 20 to transmit the digital image 33 to a back-end server 40 after the digital image 33 is completely stored into a memory of the mobile communication device 30. The other method is performing a streaming transmission, which includes the step of using a wireless communication network to transmit a portion of the digital image 33 to a back-end server 40 at the same time when the portion of the digital image 33 is captured, until the digital image 33 is completely captured and transmitted to the server 40 to be re-composed into a complete digital image 33.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method of using mobile communication apparatus to translate image text, comprising:
obtaining a digital image containing image texts from a mobile communication device having an image capture unit and a display unit;
using a wireless communication network to transmit the digital image into a server;
identifying the digital image as a corresponding text;
translating the corresponding text into a description content;
using the wireless communication network to transmit the description content from the server back to the mobile communication device; and
displaying the description content on the display unit of the mobile communication device.

2. The method of using mobile communication apparatus to translate image text as claimed in claim 1, wherein the description content and the corresponding text comprise a same or a different language.

3. The method of using mobile communication apparatus to translate image text as claimed in claim 1, wherein the image texts contained in the digital image comprise words, phrases, or articles.

4. The method of using mobile communication apparatus to translate image text as claimed in claim 1, wherein before the step of identifying the digital image as a corresponding text, the method further comprises a step of using an image processing program in the server to mark out text image regions in advance.

5. The method of using mobile communication apparatus to translate image text as claimed in claim 4, wherein the image processing program for marking out the text image regions comprises image background removal technology, edge detection technology, or color regional segmentation technology.

6. The method of using mobile communication apparatus to translate image text as claimed in claim 4, wherein after the step of using an image processing program in the server to find out text image regions in advance, the method further comprises a step of using a text group classification program in the server to classify the text image regions into a plurality of groups.

7. The method of using mobile communication apparatus to translate image text as claimed in claim 6, wherein before the step of obtaining a digital image containing image texts from a mobile communication device with image capture function, the method further comprises displaying a boundary mark on interface of the display unit, and the step of identifying the digital image as a corresponding text is identifying a group closest to center of the boundary mark region.

8. The method of using mobile communication apparatus to translate image text as claimed in claim 6, wherein before the step of obtaining a digital image containing image texts from a mobile communication device with image capture function, the method further comprises adding a mark to the image text scope to be translated in the interface of the display unit; and in the step of transmitting the digital image into a back-end server through wireless transmission, the method further comprises a step of transmitting a position information of the mark, calculating a group closest to the position of the mark in the groups for performing a subsequent identification of the group as a corresponding text.

9. The method of using mobile communication apparatus to translate image text as claimed in claim 1, wherein the step of obtaining a digital image containing image texts from a mobile communication device having an image capture unit and a display unit comprises a step of using a wireless communication network to transmit the digital image to the back-end server after the digital image is completely stored into a memory of the mobile communication device.

10. The method of using mobile communication apparatus to translate image text as claimed in claim 1, wherein the step of obtaining a digital image containing image texts from a mobile communication device having an image capture unit and a display unit comprises a step of using a wireless communication network to transmit a portion of the digital image to a back-end server at the same time when the portion of the digital image is captured, until the digital image is completely captured and transmitted to the server.

11. The method of using mobile communication apparatus to translate image text as claimed in claim 1, wherein the wireless communication network comprises a general packet radio service (GPRS) or wireless fidelity (WiFi).

12. The method of using mobile communication apparatus to translate image text as claimed in claim 1, wherein the digital image of the mobile communication device is captured by a camera or a video recorder.

13. The method of using mobile communication apparatus to translate image text as claimed in claim 1, wherein the mobile communication device comprises a mobile phone, personal digital assistant (PDA), ultra mobile PC (UMPC), or notebook (NB) with data transmission capability.

14. A system of using mobile communication apparatus to translate image text, comprising:
a wireless communication network;
a mobile communication device communicated with the wireless communication network, having an image capture unit and a display unit, wherein the image capture unit is used to capture a digital image containing image texts, and transmit the digital image to the wireless communication network; and
a server communicated with the wireless communication network, having an image processing program, a text group classification program, a text identification program, and a translation program, for performing image text region identification, text group classification, text identification, and translation processing on the digital image uploaded by the mobile communication device, so as to generate a description content, and feeding back the description content to the mobile communication device via the wireless communication network to be displayed by the display unit.

15. The system of using mobile communication apparatus to translate image text as claimed in claim 14, wherein the wireless communication network comprises a general packet radio service (GPRS) or wireless fidelity (WiFi).

16. The system of using mobile communication apparatus to translate image text as claimed in claim 14, wherein the mobile communication device comprises a mobile phone, personal digital assistant (PDA), ultra mobile PC (UMPC), or notebook (NB) with data transmission capability.

17. The system of using mobile communication apparatus to translate image text as claimed in claim 14, wherein the image capture unit of the mobile communication device comprises a camera or a video recorder.
